(19) United States
(12) Patent Application Publication
(10) Pub. No.: US 2011/0221574 A1
(43) Pub. Date: Sep. 15, 2011

(54) APPARATUS, SYSTEM, METHOD AND RFID TAG FOR THE LOCATION OF DEVICES INTEGRATED INTO A BUILDING

(76) Inventors: Roland Eckl, Munchen (DE); Michael Jäger, Munchen (DE)

(21) Appl. No.: 13/129,521

(22) PCT Filed: Sep. 8, 2009
(86) PCT No.: PCT/EP09/61593

§ 371 Date: May 16, 2011

(30) Foreign Application Priority Data
Nov. 20, 2008 (DE) 10 2008 058 297.2

(51) Int. Cl. H04Q 5/22

(52) U.S. Cl. 340/10.1

(57) ABSTRACT

For locating of devices installed in a building, the devices are provided with RFID tags, on which data pertaining to the devices are stored and which emit only in a predetermined range. A locating apparatus has a receiver module for receiving data pertaining to a device from an RFID tag which is attached to the device which is installed in a room in the building; a position data capture module for capturing the device position; and a data management module for identifying the device position as at least one coordinate of a coordinate system and for storing the position thereby identified with the data pertaining to the device. The coordinate system is based on at least one area of the room. A fast, flexible and comprehensive locating of devices installed in a building can be used, for example, with respect to the installation, service and maintenance of such devices.

### CROSS-REFERENCE TO RELATED APPLICATIONS

This application is a U.S. National Stage Application of International Application No. PCT/EP2009/061593 filed Sep. 8, 2009, which designates the United States of America, and claims priority to DE Application No. 10 2008 058 297.2 filed Nov. 20, 2008, the contents of which are hereby incorporated by reference in their entirety.

### TECHNICAL FIELD

The invention relates to the locating of devices integrated into a building. In particular the present invention relates to an apparatus, a system, method and an RFID tag for the locating of devices integrated into a building. The present invention also accordingly relates to computer program products and data carriers designed for the locating of devices integrated into a building.

### BACKGROUND

Numerous control units (frequently also called actuators) and sensors are generally installed in purpose-built constructions or in building automation. These can be partially or completely connected to each other, either wirelessly or, for example, via a bus system (for example KNX/EIB, BACnet, etc.). An integrated application, for example by connecting individual devices to a common bus, allows flexible control of these individual devices and/or a plurality of combined devices and complex regulation of control units as a function of their sensor system or additional context information.

Devices also exist which do not have to associated with building automation (for example a projector in a conference room), but which can still be part of an installation and be integrated into a building.

Specific examples of devices which are integrated into or installed in buildings are blind or door controllers. In particular these devices are often integrated or installed so as to be concealed.

In general there is a large number of different devices with different fields of application which are installed in buildings.

The term “device” will hereinafter be generally used for those devices, apparatuses, units, components, systems or modules which are intended for integration or installation in a building. The possibility of connecting the devices is a possible option in this case and not an essential requirement. Furthermore, the devices can be integrated or installed so as to be visible or concealed, concealed integration usually relating to walls, ceilings and/or floors of the building.

A large number of problems occur during the installation, adjustment, programming and servicing of such devices. Some of these problems will be briefly outlined below:
It is not always possible to correctly check specifications. In this connection it should if possible be ensured as early as possible during installation that the devices have been installed according to the respective type and installation location and/or in accordance with the specifications of the architect and/or builder.
During stock control it must be determined whether all (ordered) devices have actually been integrated and whether all integrated devices were actually ordered in the existing form. Stock control is always associated with great outlay, during which the occurrence of errors cannot be ruled out.
Holding data pertaining to the devices is also associated with a great deal of effort. Such data can, by way of example, include type, properties and configurations, etc.

All these problems occur in particular as a result of the fact that detection of the devices has previously only been carried out manually and at most with provisional assistance from technical components, with most of these being designed very specifically with respect to their field of application and so as to be very limited with respect to their function.

Checking specifications is carried out for example by way of manual inspection, it being checked whether devices of the correct type have been integrated at the correct or predetermined position. This is usually performed by comparison with specifications in a listing.

Stock control can in certain cases, for example in the lighting sector, be carried out with the assistance of barcode readers. Using codes or identifications read with barcode readers it is checked at which location a luminescent body has been integrated. However, only one comparison of the actual stock with the desired stock can be made, knowledge about all luminescent bodies being a necessary requirement hereby.

If data pertaining to the devices is to be held then this is often performed using a control function which can be initiated for example by way of a key or another activation means. In terms of software the programming mode is activated for the respective device. The hardware address is conveyed on the bus and connected installation software can be made aware of the device. The specific device can in this way be linked with an entity in the system and be referenced again later. It can only be determined in a subsequent phase, the actual programming phase, whether the properties (for example an application program) can actually be combined with the referenced entity. However, no locating takes place with this method. Usually only certain address patterns are used for the approximate allocation to typical in-house infrastructures, for example only a reference to a conference room is held.

Different procedures are currently used if data pertaining to the integrated devices or devices to be integrated are to be held.

In a conventional procedure possible programs and adjustment possibilities of a device are stipulated by the installer. A device usually comprises an impossible command or unsupported application programming only from the point at which a corresponding demand is made of the device via a bus connection.

According to a further conventional approach, devices are manually recorded in the building topology. This can take place in a conventional building plan by transmitting corresponding information (for example by drawing them in during installation or by using specifications), or by direct entry in a digital application (for example a CAD application on a notebook). However, the problem of identifying and distinguishing the actually installed devices results for a system in the process. Manual inputs are often activated for this purpose but these are error-prone and it cannot always be ensured therewith whether all installed devices or devices to be installed have actually been taken into account. In particular it is not possible in this case to ensure that both the additional manual inputs and the manual entries are actually undertaken in the building topology, and even if they are these are usually not consistent and/or redundant.

As a rule it is generally the case for the conventional procedure that as the number of devices to be installed or integrated increases, the effort, which is high anyway, for the processes that are carried out manually is subject to ever more of an increase.

### SUMMARY

According to various embodiments, an improved solution to locating or the location of devices which are to be integrated into or installed in buildings can be provided.

According to an embodiment, an apparatus for the location of devices installed in a building, may comprises—a receiver module which is configured to receive data pertaining to a device from an RFID tag, wherein the RFID tag is attached to the device, wherein the device is integrated into a room in the building;—a position data capture module which is configured to capture the position of the device in the room after receiving the data pertaining to the device; and—a data management module which is configured to identify the position of the device as at least one coordinate of a coordinate system and to store the position identified with the data pertaining to the device, wherein the coordinate system is based on at least one area of the room.

According to a further embodiment, the RFID tag can be configured to only emit in a predetermined range, and the receiver module receives the data pertaining to the device if the apparatus is positioned in the predetermined range. According to a further embodiment, the receiver module receives the data pertaining to the device if the apparatus has a substantially frontal position with respect to the device. According to a further embodiment, the apparatus may comprise at least one of the following modules:—a display module which is configured to display that the receiver module is receiving the data pertaining to the device; and—a signaling module which is configured to signal that the receiver module is receiving the data pertaining to the device. According to a further embodiment, the apparatus may comprise an input module which is configured to input the position of the device. According to a further embodiment, the data management module may be configured to manage a digital plan of the room in the building and to identify and store the position of the device on the digital plan.

According to another embodiment, an RFID tag may be configured to provide data pertaining to a device, wherein the RFID tag is predetermined and configured for attachment to the device, to only emit in a predetermined range, and wherein the RFID tag comprises a transmitter module which is configured to transmit the data pertaining to the device if the device is integrated into a building and if an apparatus designed for receiving the data is positioned in the predetermined range.

According to a further embodiment of the RFID tag, the apparatus designed for receiving the data can be an apparatus as described above.

According to yet another embodiment, a system for the location of devices integrated into a building, may comprises:—a receiver module which is configured to receive data pertaining to a device from an RFID tag, wherein the RFID tag is attached to the device, wherein the device is integrated into a room in the building;—a position data capture module which is configured to capture the position of the device in the room after receiving the data pertaining to the device; and—a data management module which is configured to identify the position of the device as at least one coordinate of a coordinate system and to store the position identified with the data pertaining to the device, wherein the coordinate system is based on at least one area of the room.

According to yet another embodiment, a computer program product may comprise a coding which is configured to implement a system described above.

According to yet another embodiment, a data carrier may comprise a computer program product as described above.

According to yet another embodiment, a method for the location of devices integrated into a building, may comprises:—receiving data pertaining to a device from an RFID tag, wherein the RFID tag is attached to the device, wherein the device is integrated into a room in the building; detecting a position of the device in the room in the building after receiving the data pertaining to the device; identifying the position of the device as at least one coordinate of a coordinate system, wherein the coordinate system is based on at least one area of the room; and storing the position identified with the data pertaining to the device.

According to a further embodiment of the method, the RFID tag may be configured to only emit in a predetermined range, and wherein the data pertaining to the device are only received from the predetermined range. According to a further embodiment of the method, the method may comprise at least one of the following steps:—displaying that the data pertaining to the device is being received, and—signaling that the data pertaining to the device is being received. According to a further embodiment of the method, the method may comprise an identification of the position of the device on a digital plan of the room in the building.

According to yet another embodiment, a computer program product may comprise a coding, which is configured to implement a method as described above.

According to yet another embodiment, a data carrier may comprise a computer program product as described above.

### BRIEF DESCRIPTION OF THE DRAWINGS

Embodiments will be described in detail hereinafter with reference to the accompanying figures below, in which:

FIG. 1 shows an apparatus and a system for the location of devices integrated into a building according to one exemplary embodiment,

FIG. 2 shows an RFID tag according to one exemplary embodiment,

FIG. 3 shows interaction of the apparatus for the location of devices integrated into a building and the RFID tag according to one exemplary embodiment,

FIG. 4 shows an embodiment of the apparatus for the location of devices integrated into a building according to one exemplary embodiment, and

FIG. 5 shows a further embodiment of the apparatus for the location of devices integrated into a building according to a further exemplary.

### DETAILED DESCRIPTION

According to various embodiments, an apparatus for the location of devices integrated into a building, may comprises:
a receiver module which is configured to receive data pertaining to a device from an RFID tag, wherein the RFID tag is attached to the device, wherein the device is integrated into a room in the building;
a position data capture module which is configured to capture the position of the device in the room after receiving the data pertaining to the device; and
a data management module which is configured to identify the position of the device as at least one coordinate of a coordinate system and to store the position identified with the data pertaining to the device, wherein the coordinate system is based on at least one area of the room.

According to the various embodiments location of or locating devices, which are integrated into or installed in a building, determining or holding positions of the devices in a building (or in the individual rooms of buildings, and, if data pertaining to the devices exists, is taken to mean the capture of data pertaining to the devices as well. The data pertaining to the devices can comprise a large number of different items of information, for example the context of the integration or installation, possible connections to further devices, device-specific information (for example type, features, compatibility with other devices, etc.).

The various embodiments thus allow a versatile solution to locating devices which can be employed in various contexts, for example during specification control, stock control, determining data pertaining to the installed or integrated devices, etc. According to various embodiments devices can be located both during installation and thereafter. The devices can therefore, if required, also be located subsequently, it being possible to carry out complete as well as supplementary or rectifying location. In the latter case the information pertaining to the devices, including the positions, can be captured again, supplemented, deleted and/or modified or rectified in the event of non-arrival or non-existence. Furthermore, a consistent location of devices is carried out. In other words, consistent capturing of data (including positions) pertaining to the devices is enabled, wherein the correctness of information and data is simultaneously ensured. Furthermore, the various embodiments allow the fast, comprehensive and efficient location of devices.

According to one exemplary embodiment the position of the device can be an accurate position detail.

According to a further exemplary embodiment the position of the device can be a relative position detail.

In both cases the position of the device indicates a (optimally accurate or relative) coordinate of a coordinate system which is based on at least one area of the room. The area of the room can be for example a wall, ceiling or the floor. The coordinate system can be a one-dimensional, two-dimensional or three-dimensional coordinate system, i.e. the coordinates are also illustrated in accordance with one-dimensional, two-dimensional or three-dimensional details.

If the coordinate system is, for example, one-dimensional and based on a wall, the coordinate can, for example, represent a detail which states that the located device is provided on or in the wall 2.3 m from the left corner of the wall. This detail can be an optimally accurate or relative detail.

The various embodiments thus allow a flexible implementation in the location of devices. Quick detection of positions of devices is also ensured in the process.

The position details can also be used to denote a marking of the positions of the devices on a digital plan of the room in a further, subsequent step. This can take place for example by transmitting the captured position details to a corresponding application in another device or in the same device. Various embodiments are possible here.

According to one exemplary embodiment the RFID tag (Radio Frequency Identification Tag) is configured to only emit in a predetermined range, the receiver module receiving the data pertaining to the device if the apparatus is positioned in the predetermined range.

This prevents emission into other rooms. RFID tags attached to integrated or installed devices therefore only emit in one direction which corresponds to the installation or integration direction. This is very advantageous in particular in purpose-built constructions because in buildings of this kind thin (i.e. non-shielding) partitions may be used, and otherwise devices from other rooms could be wrongly detected. Furthermore, devices can be precisely located in the horizontal and/or vertical direction(s).

According to one exemplary embodiment the receiver module therefore receives data pertaining to the device if the apparatus has a substantially frontal position or positioning with respect to the device.

According to one exemplary embodiment the apparatus comprises at least one of the following modules:
a display module which is configured to display that the receiver module is receiving the data pertaining to the device; and
a signaling module which is configured to signal that the receiver module is receiving the data pertaining to the device.

It is thus announced that an integrated device has been identified and that data transmission has been activated by the RFID tag. This is particularly advantageous if the device has been installed or integrated so it cannot be seen (for example is situated in the wall, ceiling or in the floor of a room).

According to one exemplary embodiment the apparatus comprises an input module which is configured to input the position of the device. The position is given in relation to the coordinate system which is based on at least one area of the room. Devices may thus be located quickly and informatively.

According to a further exemplary embodiment the data management module is configured to manage a digital plan of the room in the building and to identify and store the position of the device on the digital plan. The position in relation to the digital plan is given here. As already described, this position can be a relative position, which indicates an approximate location of the device in the plan, or an accurate position or position that is as accurate as possible, i.e. a deviation from the accurate position is allowed. Devices may thus be located quickly and in a visually informative manner.

According to other embodiments, an RFID tag which can be configured to provide data pertaining to a device, wherein the RFID tag is predetermined and configured for attachment to the device, to only emit in a predetermined range, and wherein the RFID tag comprises a transmitter module which is configured to transmit data pertaining to the device if the device is integrated into a building and if an apparatus designed for receiving the data is positioned in the predetermined range.

The RFID tag is preferably attached to the device in such a way that it emits in the direction from which the device has been installed or integrated and from which the device is accessible.

A possibility for detecting or locating devices in rooms in a building is therefore offered. Devices that are installed or integrated so as to be concealed can also be identified and detected.

Only visible devices may therefore be detected if the possibility of locating devices by means of barcodes is considered.

GPS (Global Positioning System)-based systems for locating or the location of objects often cannot be used because a GPS signal cannot always be received inside buildings. Solutions which use a GPS-based system inside buildings by way of satellite simulation (Indoor GPS) in turn require excessive installation effort for the locating system.

Methods that are independent of application and which use triangulation in a radio network for locating or the location of objects have the drawback that they supply positions that are too inaccurate. A triangulation based on ad hoc networks could allow more precise position details but a form of radio technology which is immune to reflections would have to be used for this. However, such a process is very expensive and inefficient. Furthermore, an additional installation of the radio network is sometimes also necessary beforehand.

The various embodiments therefore allow accurate position detection of devices which can also be carried out efficiently and effectively.

According to one exemplary embodiment the apparatus designed to receive the data corresponds with the apparatus, already outlined above and described in more detail below, for the location of devices integrated into a building.

According to other embodiments, a system for the location of devices installed in a building, may comprises:
a receiver module which is configured to receive data pertaining to a device from an RFID tag, wherein the RFID tag is attached to a device, wherein the device is integrated into a room in the building;
a position data capture module which is configured to capture the position of the device in the room after receiving the data pertaining to the device; and
a data management module which is configured to identify the position of the device as at least one coordinate of a coordinate system and to store the position identified with the data pertaining to the device, wherein the coordinate system is based on at least one area of the room.

According to other embodiments, a computer program product may comprise a coding which is configured to implement (and operate) the system outlined above and described in more detail below. The coding can be provided in at least one data carrier.

According to one exemplary embodiment the computer program product is configured to operate the system if the computer program product is executed by means of a computing unit, such as a processor for example.

According to other embodiments, at least one data carrier may comprises the computer program product described above.

It should be noted here that the system for the location of devices integrated into a building can be installed on the apparatus for the location of devices integrated into a building. In other words, the systems can substantially comprise modules which are configured to perform functions which correspond with those of the modules of the apparatus. The modules of the system can be regarded as modules which control the modules of the apparatus or correspond with these.

The modules of the system can in the process be of a physical and/or virtual nature. In other words, the system can be seen as a system controlling the apparatus (for the location of devices integrated into a building). Therefore, the system comprises similarly configured modules to those of the apparatus for the location of devices integrated into a building, even if these are not always explicitly stated in the description.

According to yet other embodiments, a method for the location of devices integrated into a building, may comprise:
receiving data pertaining to a device from an RFID tag, wherein the RFID tag is attached to the device, wherein the device is integrated into a room in the building;
detecting a position of the device in the room in the building after receiving the data pertaining to the device;
identifying the position of the device as at least one coordinate of a coordinate system, wherein the coordinate system is based on at least one area of the room; and
storing the position identified with the data pertaining to the device.

It should be noted that the steps of the method can be seen as corresponding with the mode of operation of the apparatus for the location of devices integrated into a building.

Therefore, for example, the method according to one exemplary embodiment comprises at least one of the following steps:
displaying that the data pertaining to the device is being received; and
signaling that the data pertaining to the device is being received.

The method according to one exemplary embodiment can, moreover, comprise an identification of the position of the device on a digital plan of the room in the building.

According to yet other embodiments, a computer program product may comprise a coding, which is configured to implement (and carry out) the method outlined above and described in more detail below. The coding can be provided in at least one data carrier.

According to one exemplary embodiment the computer program product is configured to carry out the method if the computer program product is executed by means of a computing unit, such as a processor.

According to yet other embodiments, at least one data carrier may comprise the above computer program product.

The various embodiments therefore relate to the location of devices integrated into a building. The devices are provided with RFID tags on which data pertaining to the devices are stored and which emit only in a predetermined range. A location apparatus comprises: a receiver module for receiving data pertaining to a device from an RFID tag, wherein the RFID tag is attached to the device and the device is integrated into a room in the building; a position data capture module to capture the position of the device in the room; and a data management module to identify the position of the device as at least one coordinate of a coordinate system and to store the position identified with the data pertaining to the device. The coordinate system is based on at least one area of the room. The various embodiments allows flexible, comprehensive and fast location of devices which are integrated into a building and can, by way of example, be used with respect to installation, maintenance and stock management.

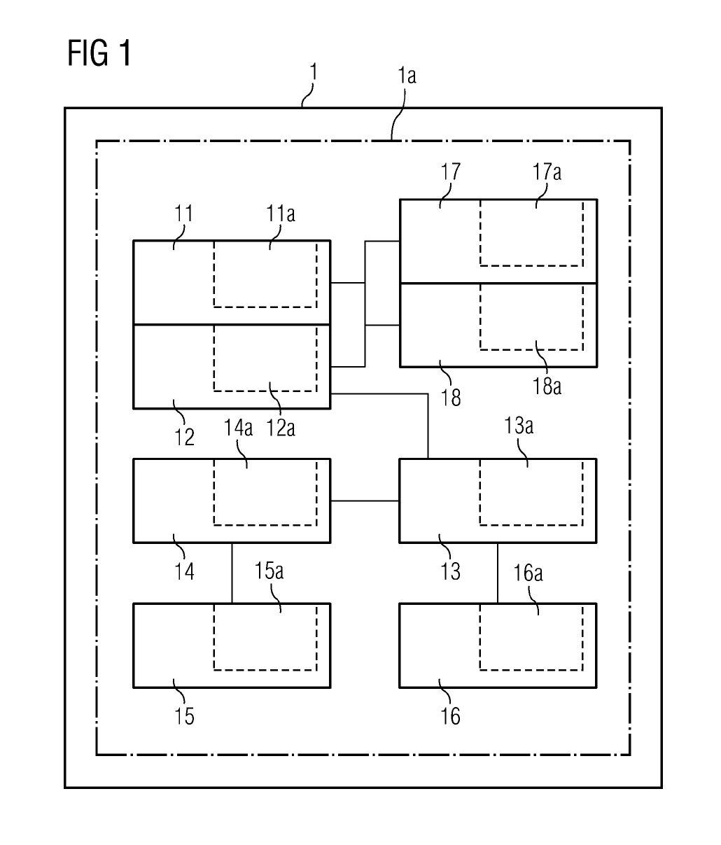

As already mentioned, FIG. 1 shows an apparatus 1 and a system 1a for the location of devices integrated into a building according to one exemplary embodiment.

According to the present exemplary embodiment the system 1a is installed in the apparatus 1 and comprises modules 11a, 12a, 13a, 14a, 15a, 16a, 17a, 18a whose functionality corresponds with the functionality of the respective modules 11, 12, 13, 14, 15, 16, 17, 18 of apparatus 1. Each of the modules 11a, 12a, 13a, 14a, 15a, 16a, 17a , 18a of the system 1a can control the respective module 11, 12, 13, 14, 15, 16, 17, 18 of the apparatus 1 or correspond with it.

The apparatus 1 comprises a transmitter module 11 which is configured to activate an RFID tag for the transmission of data. The RID tag is attached to a device which is integrated into or installed in a room in a building. The data relate to the respective device. The manner of activation of an RFID tag is generally known and can be carried out using conventional procedures.

The apparatus 1 also comprises a receiver module 12 which is configured to receive the data pertaining to the device from the (activated) RFID tag. The transmitter module 11 and the receiver module 12 can be two separate modules or be integrated into a transceiver module.

According to the present exemplary embodiment the apparatus 1 also comprises a display module 17 (for example a lamp which can light up) and a signaling module 18 (for example a modules for generating and emitting acoustic signals). If the data are received by the receiver module 12 and/or the RFID tag is activated by the transmitter module 11, this can be displayed by the display module 17 and/or signaled by the signaling module 18. For this purpose the display module 17 and the signaling module 18 are connected to the transmitter module 11 and the receiver module 12. When the respective function is performed the transmitter module 11 and/or the receiver module 12 can activate the display module 17 and/or the signaling module 18 accordingly (for example by transmitting a corresponding signal). When the respective function is ended the transmitter module 11 and/or the receiver module 12 can deactivate the display module 17 and/or the signaling module 18 accordingly (for example by transmitting a corresponding signal), whereupon the display module 17 and/or the signaling module 18 end displaying or signaling.

The apparatus 1 also comprises a data management module 13 which is configured to identify the position of the device 21 as at least one coordinate of a coordinate system and to store the position identified with the data pertaining to the device 21, wherein the coordinate system is based on at least one area (for example wall, ceiling and/or floor) of the room.

The data management module 13 can also be configured to manage a digital plan of at least one room in the building in which devices are to be located. The position can be identified on the digital plan.

According to the present exemplary embodiment the data management module 13 is also configured to manage data pertaining to the device. The functionality of management can be based on all or most of the functionalities for handling data, for example on provision, modification, insertion, amendment, deletion and storage of data and on exchange of data with further external and/or internal components, modules or apparatuses.

According to the present embodiment the apparatus 1 also comprises a position data capture module 14 which is configured to capture the position of the device after receiving the data from the RFID tag and/or after updating of the RFID tag. The position then indicates an optimally accurate or relative coordinate of a coordinate system which is based on at least one area (for example wall, ceiling and/or floor) of the room. The position data capture module 14 then passes the data pertaining to the position to the data management module 12, whereupon the data management module 12 identifies the position of the device in relation to the coordinate system or links thereto. The data management module 12 then stores the created identification or link with the position accordingly.

If the data management module 12 is configured to manage a digital plan of the room in a building, the position can be based on the digital plan. The data management module 12 can then directly identify the position of the device on the digital plan or link thereto.

The data management module 12 is further configured to obtain the data pertaining to the device from the receiver module 12 and store it together with the position of the device (created identification or link with the digital plan).

According to the present exemplary embodiment the apparatus 1 comprises an input module 15 which is configured to input the position of the device. The input module 15 is configured to pass the input position to the position data capture module 14 for further handling as described above.

According to the present exemplary embodiment the apparatus 1 also comprises an interface module 16 which is configured to exchange data between an external component or apparatus and the data management module 13. The data management module 13 can transmit data (positions of the located devices and information pertaining to the devices) to an external component via the interface module 16. The data management module 13 can also receive digital plans of at least one room in a building from the external component via the interface module 14 if the data management module 13 is adapted to manage such digital plans.

The apparatus 1 therefore allows further processing of the data obtained by the locating of devices. The apparatus 1 can also be flexibly adjusted to different rooms of different buildings.

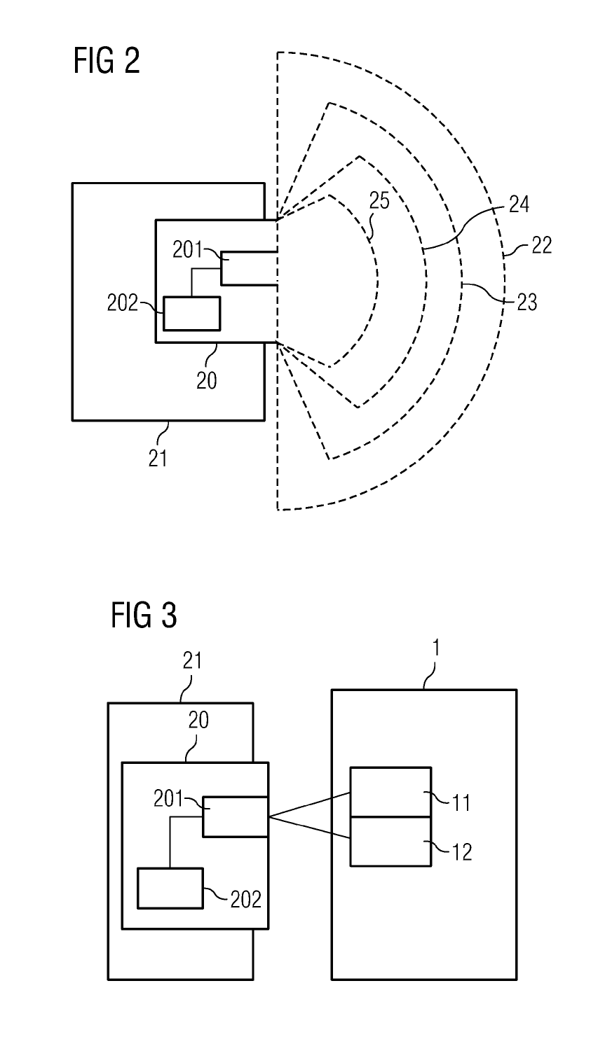

FIG. 2 shows an RFID tag 20 according to an exemplary embodiment. The RFID tag 20 is attached to a device 21 and comprises a data module 202 for storing and managing data pertaining to the device 21 and a transceiver module 201. Transceiver modules of RFID tags are generally known, therefore a conventional transceiver module 201 can be used in the RFID tag 20.

The RFID tag 20 can be provided with a clear ID or identification which, for example, can be stored in the data module 202. The ID or identification or parts of the identification can be configured in such a way that they point to certain device properties (for example type, programing modes, etc.).

To prevent emitting into other rooms the RFID tag 20 or its transceiver module 201 is configured in such a way that the RFID tag 20 only emits in one direction or in a predetermined range. The maximum emitting range 22 or the maximum transceiving range 22 of the RFID tag 20 is indicated in FIG. 2 and corresponds to a hemisphere. The emitting range of the RFID tag 20 can be adjusted, wherein the more narrow the emitting range of the RFID tag is adjusted or predetermined to be, the more precisely the device 21 is located in the horizontal and/or vertical direction(s). Examples of constricted, narrower, predetermined emitting ranges are indicated in FIG. 2 by regions between the broken lines 23, 24, 25 in the maximal emitting range 22.

FIG. 3 shows interaction of the apparatus 1 for the location of devices integrated into a building and the RFID tag 20 according to one exemplary embodiment. Interaction of a system for the location of devices integrated into a building and the RFID tag 20 can also be taken from FIG. 3 accordingly.

According to the present exemplary embodiment the RFID tag 20 or its transceiver module 201 is activated by the transmitter module 11 of the apparatus 1. The execution of such activation is generally known. The RFID tag 20 (following its activation) also transmits the data pertaining to the device 21 and stored in the data module 202 to the apparatus 1, wherein the receiver module 12 of the apparatus 1 is responsible for receiving the data pertaining to the device 21.

The present invention will described hereinafter by way of example with respect to three possible phases.

In one production phase all devices 21 which are subsequently used as part of an installation in the building services technology are provided with an RFID tag 21. The production phase can therefore already ensure a location of the devices according to various embodiments.

However, this is not an imperative requirement. The devices 21 can also be correspondingly equipped with radio tags subsequently, for example during installation of the devices or during an inventory.

A building plan can be created for example by architects or builders in a planning and installation phase. This is used as the basis for the subsequent positioning and location or location of the devices to be integrated. This plan should be provided in digital form and should have a suitable interface in order to be able to subsequently distribute the devices on the plan according to various embodiments and to allow further (provision-specific) applications based on the plan and/or the data obtained by location to be implemented.

The devices 21 (for example switches, actuators, ballasts, relays and any other relevant units equipped with RFID tags 20) are installed by installation personnel. This can take place, for example, according to specific guidelines.

The location of the devices is carried out in a logical linking phase.

The devices can be detected room-by-room. If the detecting or location of the devices is carried out room-by-room the sequences can be determined in advance for all rooms, otherwise the data pertaining to the integrated or installed devices in the plan can also be transferred following capture of the data by explicitly selecting one room. Different variations are possible here.

With room-by-room implementation the devices within a room are detected or located in a predefined sequence from a chosen starting point. This could, for example, be in the clockwise direction starting from the door, then detection or location could be carried out on the ceiling and finally on the floor. Different variations of the procedure are also possible here.

The respective partial area (wall, ceiling or floor for example) is completely covered by the location apparatus, as illustrated above. If a device is found the location apparatus indicates this by way of example by a display module such as a light emitting diode (LED) and/or by an acoustic signal which is produced by a signaling module.

Parameters and device properties, which have been transmitted from an RFID tag attached to the device to the location apparatus, can optionally be displayed on a further display component, for example on an additional display.

The following two possibilities by way of example are also available for the further course of action:

A relative positioning of the found or located device can be carried out. The user can input the relative position within the current section. An input module can display a bar, it being possible to input the relative position by lightly touching or pressing the bar. If, for example, the middle of the bar is pressed, this means that the current device is in the center of the current section, for example in the middle of the wall currently being captured. The input corresponds with the input of an accurate or relative coordinate of the device. In the case of an input via the bar the coordinate is a one-dimensional coordinate which has a coordinate system which is based on the wall being captured. As in the present example a one-dimensional coordinate system is being considered, the coordinate system will be based on the length or the height of the wall being captured.

Absolute positioning may also be carried out. The user is provided with an input module having a more accurate input option. Thus, for example, a numeric keypad can be provided as the input module of the location apparatus, via which the accurate position (for example in meters from the left) within the section can be given.

Automatic detection of the position of a device is also possible, moreover. Thus, for example, a laser distance measurement can be carried out using an appropriate position data capture module. A section of the area to be captured can be obtained via the laser distance measurement.

The location of the ceiling and the floor constitutes a special case. Only the relative or absolute spacing from the starting position can be detected in these cases. Mode switching can then take place, initiated by the touch of a button or a comparable procedure. The spacing from the room boundary on the orthogonal in relation to the previous measurement can then be input.

Two-stage detection of this kind may also be used for more precise location on walls, for instance if the vertical position should be detected in addition to the horizontal one.

Basically devices can be located with respect to the periphery of the room, i.e. in one or two dimensions with respect to a side (wall, ceiling or floor).

If all devices of a wall (equivalent to a section within the room that is currently being linked) have been detected or located a press of a button or another input signals a change of section. Devices of the following wall are now detected as described above.

The data pertaining to the located or detected devices can be sent or transmitted immediately during input, after each room, or in a given room sequence on conclusion of detection or location of all devices situated in a building complex to software that is managing the plan to accordingly maintain data pertaining to the devices therein. In the latter cases the data can be buffered on the location apparatus. Generally different methods of implementation are possible here. The above implementation serves as an exemplary one.

Following conclusion of the location process the collated data pertaining to the devices (for example device type, properties, logical location information) can be used in further processes and applications which, by way of example, manage installation of the devices or assist maintenance thereof.

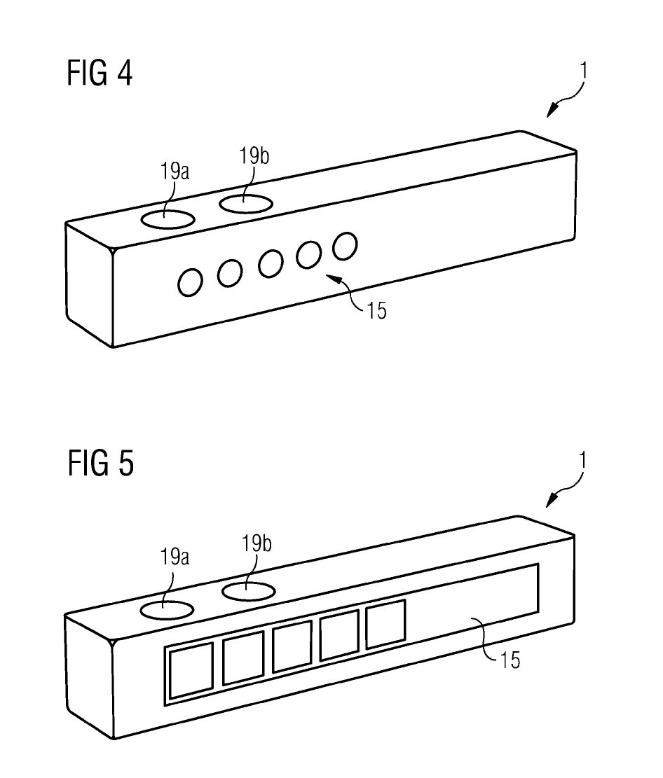

FIG. 4 and FIG. 5 show by way of example two possible embodiments of the apparatus 1 for the location of devices integrated into a building or the location apparatus.

According to the exemplary embodiments presented in FIGS. 4 and 5 the apparatuses 1 are rod-shaped in design. They can take other forms, however.

Firstly one of the sides of the apparatus 1 provides space for input modules, in this case input keys 19a, 19b. These can, by way of example, be configured to activate a change in the input mode or section or a change in the room when locating the devices. A further side of the apparatus 1 provides space for an input module 15, in this case a scaled input field to allow detection of a relative position of a device in a room.

The input module 15 (e.g. as a scale) can also be expedient for inputting in the case of an integrated absolute laser detection, for example if architecturally no absolute detection relating to an edge is given owing to curves, obtuse angles, etc. This would constitute an additional option when determining the position of a device.

According to the exemplary embodiment illustrated in FIG. 4 the input module 15 is provided as a capacitive input field to allow an input of a relative position. According to this exemplary embodiment an acknowledgement of the detected position is indicated by means of LEDs which are placed under the housing of the apparatus 1. The complete spacing display can light up in a different color if a device with an RFID tag is found or identified. Only the LEDs through to the selected or contacted position remain clearly visible (for example flashing) due to contacting of a position on the LEDs.

According to the exemplary embodiment illustrated in FIG. 5 the input module 15 is also provided as a capacitive input field. In this case it is a touchscreen or haptic screen. According to this exemplary embodiment an acknowledgement following input of the position takes place by way of a display on an LCD (Liquid Crystal Display) with the relative position being detected and displayed by rectangular-shaped LCDs.

The granularity of the scales is shown merely by way of example in FIG. 4 and FIG. 5 and it may, for example, also be configured so as to be much more fine-grain.

With respect to the data which are transmitted from an RFID tag attached to a device to the apparatus for the locating of devices, and relating to the device, it should be noted that a large number of items of information is possible here. By way of example information relating to the manufacturer, product family, product type, bus technology used (if a connection to other devices is possible), possible communication objects parameters, etc. can be stored on the RFID tag and transmitted to the location apparatus. The scope and type of data will vary depending on the device, application and installation situation.

The various embodiments offer of a series of different advantages.

Thus, for example, in contrast to barcode-based methods, for instance, no visible surface to the installed devices is required. The various embodiments can also be applied in relation to devices that are installed so as to be concealed. Furthermore, a factory-installed RFID tag is maintenance-free and is optically neutral.

In building automation this specifically means that, with sufficient range, RFID tags can be registered by devices installed in the plaster and that visible devices (for instance switches) are not superficially affected (for example by glue residues of barcode labels). By shielding or aligning the antenna or the transceiver module of the RFID tag in a predetermined direction or in a predetermined range, it may be ensured that the RFID tags, and therefore the corresponding devices as well, are not located in the wrong room.

Furthermore, in contrast to actual locating methods, no location methods (for example GPS, indoor GPS, triangulation and other locating methods) are required. Installation of additional infrastructure is therefore not required here. The accuracy to be anticipated with the aid of logical locating substantially corresponds to a conventional method, which is not optimized for the location, for location for the interior. Furthermore, precise locating (accurate to a meter) is not imperative for building automation. Locating the room, wall or the approximate alignment thereon can be sufficient in this case. In turn no ambiguous allocations can occur in the case of walls that are situated close together as is possible with radio-based location methods.

As the installation of the devices on a specific wall can be used as the starting point within the framework of the detection process (due to the specific plan), the alignment of the installed device can also clearly be seen. With a relatively thin wall, as is used in purpose-built constructions, the alignment of a device could not easily be determined with a purely radio-based locating method. In this case it would not be evident on which side of the wall measured values are being detected. Additional steps for determining this factor would be necessary, and this would lead to high expenditure.

The various embodiments therefore provide accurate, fast, efficient and comprehensive locating of devices which are integrated into or installed in a building.

Although the invention has been described above with reference to the exemplary embodiments according to the accompanying drawings, it is evident that the invention is not limited thereto but can be modified within the scope of the inventive idea disclosed above and in the dependent claims. It is understood that there may be further exemplary embodiments which illustrate the principle of the invention and are equivalent and that therefore various modifications can be implemented without departing from the scope of the invention. The modules of the apparatus or the system for locating devices which are installed in or integrated into buildings can therefore have different designs, it being possible for one module to carry out a plurality of inventive functions and/or for one inventive function to be carried out by a plurality of modules. The modules can be hardware or software modules. Furthermore, the procedure when locating devices as described above can be configured differently within the scope of the present invention. The form of the apparatus can also vary in design; various input modules for inputting a (relative) position of a device are possible. An absolute position can likewise be obtained using different suitable measuring methods.

What is claimed is:

1. An apparatus for the location of devices installed in a building, wherein the apparatus comprises:
a receiver module which is configured to receive data pertaining to a device from an RFID tag, wherein the RFID tag is attached to the device, wherein the device is integrated into a room in the building;
a position data capture module which is configured to capture the position of the device in the room after receiving the data pertaining to the device; and
a data management module which is configured to identify the position of the device as at least one coordinate of a coordinate system and to store the position identified with the data pertaining to the device, wherein the coordinate system is based on at least one area of the room.

2. The apparatus according to claim 1, wherein the RFID tag is configured to only emit in a predetermined range, and wherein the receiver module receives the data pertaining to the device if the apparatus is positioned in the predetermined range.

3. The apparatus according to claim 1, wherein the receiver module receives the data pertaining to the device if the apparatus has a substantially frontal position with respect to the device.

4. The apparatus according to claim 1, wherein the apparatus comprises at least one of the following modules:
a display module which is configured to display that the receiver module is receiving the data pertaining to the device; and
a signaling module which is configured to signal that the receiver module is receiving the data pertaining to the device.

5. The apparatus according to claim 1, wherein the apparatus comprises an input module which is configured to input the position of the device.

6. The apparatus according to claim 1, wherein the data management module is configured to manage a digital plan of the room in the building and to identify and store the position of the device on the digital plan.

7. An RFID tag which is configured to provide data pertaining to a device, wherein the RFID tag is predetermined and configured for attachment to the device, to only emit in a predetermined range, and wherein the RFID tag comprises a transmitter module which is configured to transmit the data pertaining to the device if the device is integrated into a building and if an apparatus designed for receiving the data is positioned in the predetermined range.

8. The RFID tag according to claim 7, wherein the apparatus designed for receiving the data is an apparatus comprising:
a receiver module which is configured to receive data pertaining to a device from an RFID tag, wherein the RFID tag is attached to the device, wherein the device is integrated into a room in the building;
a position data capture module which is configured to capture the position of the device in the room after receiving the data pertaining to the device; and
a data management module which is configured to identify the position of the device as at least one coordinate of a coordinate system and to store the position identified with the data pertaining to the device, wherein the coordinate system is based on at least one area of the room.

9. A system for the location of devices integrated into a building, wherein the system comprises:
a receiver module which is configured to receive data pertaining to a device from an RFID tag, wherein the RFID tag is attached to the device, wherein the device is integrated into a room in the building;
a position data capture module which is configured to capture the position of the device in the room after receiving the data pertaining to the device; and
a data management module which is configured to identify the position of the device as at least one coordinate of a coordinate system and to store the position identified with the data pertaining to the device, wherein the coordinate system is based on at least one area of the room.

10. A computer program product comprising a computer readable medium storing instructions which when executed on a computer implement a system according to claim 9.

11. (canceled)

12. A method for the location of devices integrated into a building, wherein the method comprises:
receiving data pertaining to a device from an RFID tag, wherein the RFID tag is attached to the device, wherein the device is integrated into a room in the building;
detecting a position of the device in the room in the building after receiving the data pertaining to the device;
identifying the position of the device as at least one coordinate of a coordinate system, wherein the coordinate system is based on at least one area of the room; and
storing the position identified with the data pertaining to the device.

13. The method according to claim 12, wherein the RFID tag is configured to only emit in a predetermined range, and wherein the data pertaining to the device are only received from the predetermined range.

14. The method according to claim 12, wherein the method comprises at least one of the following steps:
displaying that the data pertaining to the device is being received, and
signaling that the data pertaining to the device is being received.

15. The method according to claim 12, wherein the method comprises an identification of the position of the device on a digital plan of the room in the building.

16. A computer program product comprising a computer readable medium storing instructions, which when executed on a computer implement a method as claimed in claim 12.

17. (canceled)

18. The computer program product according to claim 16, wherein the RFID tag is configured to only emit in a predetermined range, and wherein the data pertaining to the device are only received from the predetermined range.

19. The computer program product according to claim 16, wherein the method comprises at least one of the following steps:
displaying that the data pertaining to the device is being received, and
signaling that the data pertaining to the device is being received.

20. The computer program product according to claim 16, wherein the method comprises an identification of the position of the device on a digital plan of the room in the building.
